(19) United States
(12) Patent Application Publication
(10) Pub. No.: US 2012/0208116 A1
(43) Pub. Date: Aug. 16, 2012

(54) BIS(ENYLARYL)ARYLAMINE CHARGE TRANSPORT LAYER CONTAINING PHOTOCONDUCTORS

(75) Inventor: Jin WU, Pittsford, NY (US)

(73) Assignee: XEROX CORPORATION, NORWALK, CT (US)

(21) Appl. No.: 13/026,539

(22) Filed: Feb. 14, 2011

(51) Int. Cl. G03G 5/047

(52) U.S. Cl. 430/58.8; 430/58.85

(57) ABSTRACT

A photoconductor containing an optional supporting substrate layer, a photogenerating layer, a bis(enylaryl)arylamine containing charge transport layer, and a top overcoat layer, which includes charge transport compounds and melamine resins.

There is disclosed a photoconductor comprising a supporting substrate, an optional hole blocking layer, an optional adhesive layer, a photogenerating layer, a charge transport layer that includes a charge transporting compound, and a bis(enylaryl)arylamine, and an overcoat layer comprising a charge transport compound and a melamine resin.

### BACKGROUND

A number of photoconductors that are selected for imaging systems, such as xerographic imaging processes, are known. These photoconductors usually contain certain photogenerating layer pigments and charge transport layer components. A problem associated with a number of the known photoconductors is that undesirable image ghosting may result on the developed xerographic images, which ghosting causes image defects, and unwanted background deposits. This ghosting in turn may require the untimely replacement of photoconductors at significant costs. Also, many known photoconductors possess high residual potentials, designated as V_{residual} (V_{L}) that cause the photoconductors cyclic stability to be unsatisfactory.

Photoconductors that have a minimum or lack resistance to abrasion from dust, charging rolls, toner, and carrier are known. Further, the surface layers of photoconductors are subject to scratches, which decrease their lifetime, and in xerographic imaging systems adversely affect the quality of the developed images. While used photoconductor components can be partially recycled, there continues to be added costs and potential environmental hazards when recycling.

Thus, there is a need for ghost resistant photoconductors with excellent or acceptable mechanical characteristics, especially in xerographic systems where biased charging rolls (BCR) are used.

Additionally, there is a need for photoconductors where crystallization of the charge transport compound is mimimized or substantially avoided.

Also, there is a need for photoconductors with minimal ghosting characteristics where minimal refers to a ghosting grade of from about −1 to about −3.5, from about −1 to about 0 (zero), from about −1 to about −3, from about −2.5 to about 0 (zero), from about −2.5 to about −1, or from about −1 to about −2.

There is also a need for photoconductors with acceptable low ghosting characteristics, and which photoconductors permit the rapid transport of holes in the charge transport layer present in the photoconductor.

Photoconductors with excellent cyclic characteristics and stable electrical properties, stable long term cycling, minimal charge deficient spots (CDS), and acceptable lateral charge migration (LCM) characteristics, such as excellent LCM resistance, are also desirable needs.

These and other needs are believed to be achievable with the photoconductors disclosed herein.

### SUMMARY

Disclosed is a photoconductor comprising a supporting substrate, an optional hole blocking layer, an optional adhesive layer, a photogenerating layer, a charge transport layer comprising a mixture of a charge transport compound and a bis(enylaryl)arylamine, and an overcoat layer comprising a charge transport compound and a melamine resin.

Also, disclosed is a photoconductor comprising a supporting substrate, a photogenerating layer, and a charge transport layer comprising a blend of a first charge transport compound and a second bis(butadienylaryl)arylamine charge transport compound additive, and a crosslinked overcoat layer comprising a charge transport compound, a melamine resin, and a hydroxyl terminated fluorinated additive, a hydroxyl silicone modified polyacrylate additive, or mixtures thereof.

Further, disclosed is a photoconductor comprising a photogenerating layer, a bis(enylaryl)arylamine containing charge transport layer, and an overcoat layer comprising a charge transport compound and a melamine resin, and wherein the photoconductor has a ghosting grade of from about −2.5 to about zero.

### FIGURES

There are provided the following Figures to further illustrate the photoconductors disclosed herein.

FIG. 1 illustrates an exemplary embodiment of an overcoated layered photoconductor of the present disclosure.

FIG. 2 illustrates a graph of photoconductor surface potentials in volts (V) versus the A zone HMT cycles where HMT refers to a known high speed Hyper Mode Test used to determine the xerographic cyclic stability of the photoconductors illustrated herein.

FIG. 3 illustrates a graph of photoconductor surface potentials in volts (V) versus the J zone HMT cycles where HMT refers to a known high speed Hyper Mode Test used to determine the xerographic cyclic stability of the photoconductors illustrated herein.

### EMBODIMENTS

In embodiments of the present disclosure, there is illustrated a photoconductor comprising in sequence a supporting substrate, an optional anticurl layer, an optional hole blocking layer, an optional adhesive layer, a photogenerating layer, at least one, such as from 1 to about 4, from 1 to about 2, or one, charge transport layer comprising a mixture or blend of a first charge transport component and a second charge transport component of bis(enylaryl)arylamines, and an overcoat layer.

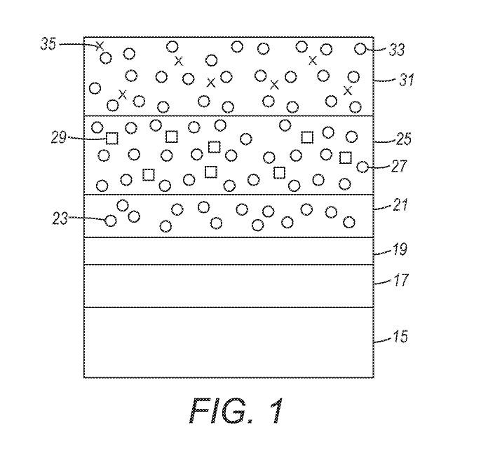

Exemplary and non-limiting examples of photoconductors, and the characteristics thereof according to embodiments of the present disclosure are depicted in FIGS. 1, 2, and 3.

In FIG. 1, there is illustrated an overcoated photoconductor comprising a supporting substrate layer 15, a hole blocking layer 17, an adhesive layer 19, a photogenerating layer 21 containing photogenerating pigments 23, a charge transport layer 25 containing charge transport compounds 27, and bis(enylaryl)arylamines, such as bis(butadienylaryl)arylamines 29, and an overcoat layer 31 containing charge transport compounds 33 and melamine resins 35.

Substrate

An optional supporting substrate can be included in the photoconductors illustrated herein. The substrate selected for the photoconductors of the present disclosure may comprise a layer of an electrically substantially nonconductive material or a layer of a conductive material. Examples of known nonconducting supporting substrate materials include polyesters, polycarbonates, polyamides, polyurethanes, and the like, and mixtures thereof.

In embodiments, when the photoconductor supporting substrate layer is not conductive, the surface may be rendered electrically conductive by depositing thereon a known electrically conductive coating like a coating of a metal oxide. The conductive coating may vary in thickness, such as from about 1 to about 50 microns, from 1 to about 35 microns, or from about 3 to about 25 microns, depending upon the optical transparency to be achieved, degree of flexibility desired, and economic factors.

An electrically conducting supporting substrate that may be selected for the photoconductors illustrated herein include metal containing polymers, titanium containing MYLAR®, metals including aluminum, nickel, steel, copper, gold, and the like, and mixtures thereof filled with an electrically conducting substance. Examples of electrically conducting substances include carbon, metallic powder, and the like, or an organic electrically conducting material.

Illustrative examples of photoconductor supporting substrates include a layer of insulating material including inorganic or organic polymeric materials, such as MYLAR® (a commercially available polymer), a MYLAR® containing titanium layer, a layer of an organic or inorganic material having a semiconductive surface layer, such as indium tin oxide or aluminum arranged thereon, or a conductive material inclusive of aluminum, chromium, nickel, brass, or the like, and mixtures thereof.

The thickness of the photoconductor supporting substrate depends on many factors, including economical considerations, electrical characteristics, adequate flexibility, availability and cost of the specific components for each layer, and the like. Thus, this layer may be of a substantial thickness, for example up to about 3,000 microns, such as from about 1,000 to about 2,000 microns, from about 500 to about 1,000 microns, or from about 300 to about 700 microns, or of a minimum thickness of from about 75 to about 100 microns. In embodiments, the thickness of this layer is from about 75 to about 300 microns, or from about 100 to about 150 microns.

The substrate may be flexible, seamless, or rigid, and may have a number of many different configurations, such as for example, a plate, a cylindrical drum, a scroll, an endless flexible belt, a drelt (a cross between a drum and a belt), and the like. In embodiments, the photoconductor substrate is in the form of a seamless flexible belt.

Anticurl Layer

In some situations, it may be desirable to coat a known anticurl layer on the back of the photoconductor substrate, particularly when the substrate is a flexible organic polymeric material. This anticurl layer, which is sometimes referred to as an anticurl backing layer, minimizes undesirable curling of the substrate. Suitable materials selected for the photoconductor anticurl layer include, for example, polycarbonates commercially available as MAKROLON®, polyesters, and the like. The anticurl layer can be of a thickness of from about 5 to about 40 microns, from about 10 to about 30 microns, or from about 15 to about 25 microns.

Ground Plane Layer

Positioned on the top side of the supporting substrate there can be included an optional ground plane such as gold, gold containing compounds, aluminum, titanium, titanium/zirconium, and other suitable known components. The thickness of the ground plane layer can be from about 10 to about 100 nanometers, from about 20 to about 50 nanometers, from about 10 to about 30 nanometers, from about 15 to about 25 nanometers, or from about 20 to about 35 nanometers.

Hole-Blocking Layer

An optional charge blocking layer or hole blocking layer may be applied to the photoconductor supporting substrate, such as an electrically conductive supporting substrate surface prior to the application of a photogenerating layer. An optional charge blocking layer or hole blocking layer, when present, is usually in contact with the ground plane layer, and also can be in contact with the supporting substrate. The hole blocking layer generally comprises any of a number of known components as illustrated herein, such as metal oxides, phenolic resins, aminosilanes, and the like, and mixtures thereof. The hole blocking layer can have a thickness of from about 0.01 to about 30 microns, from about 0.02 to about 5 microns, or from about 0.03 to about 2 microns.

Examples of aminosilanes included in the hole blocking layer can be represented by the following formulas/structures

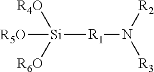

wherein R₁ is alkylene, straight chain or branched, containing from 1 to about 25 carbon atoms, from 1 to about 18 carbon atoms, from 1 to about 12 carbon atoms, or from 1 to about 6 carbon atoms; R₂ and R₃ are independently selected from the group consisting of at least one of a hydrogen atom, alkyl containing from 1 to about 12 carbon atoms, or from 1 to about 4 carbon atoms, aryl containing from about 6 to about 24 carbon atoms, from about 6 to about 18 carbon atoms, or from about 6 to about 12 carbon atoms, such as a phenyl group; and a poly(alkylene amino) group, such as a polyethylene amino) group, and where R₄, R₅ and R₆ are independently an alkyl group containing from 1 to about 12 carbon atoms, from 1 to about 10 carbon atoms, or from 1 to about 4 carbon atoms.

Specific examples of suitable hole blocking layer aminosilanes include 3-aminopropyl triethoxysilane, N,N-dimethyl-3-aminopropyl triethoxysilane, N-phenylaminopropyl trimethoxysilane, triethoxysilylpropylethylene diamine, trimethoxysilylpropylethylene diamine, trimethoxysilylpropyldiethylene triamine, N-aminoethyl-3-aminopropyl trimethoxysilane, N-2-aminoethyl-3-aminopropyl trimethoxysilane, N-2-aminoethyl-3-aminopropyl tris(ethylethoxy)silane, p-aminophenyl trimethoxysilane, N,N′-dimethyl-3-aminopropyl triethoxysilane, 3-aminopropylmethyl diethoxysilane, 3-aminopropyl trimethoxysilane, N-methylaminopropyl triethoxysilane, methyl[2-(3-trimethoxysilylpropylamino) ethylamino]-3-proprionate, (N,N′-dimethyl 3-amino)propyl triethoxysilane, N,N-dimethylaminophenyl triethoxysilane, trimethoxysilyl propyldiethylene triamine, and the like, and mixtures thereof. Yet more specific aminosilane materials are 3-aminopropyl triethoxysilane (γ-APS), N-aminoethyl-3-aminopropyl trimethoxysilane, (N,N′-dimethyl-3-amino)propyl triethoxysilane, and mixtures thereof.

The hole blocking layer aminosilane may be treated to form a hydrolyzed silane solution before being added into the final hole blocking layer coating solution or dispersion. During hydrolysis of the aminosilanes, the hydrolyzable groups, such as the alkoxy groups, are replaced with hydroxyl groups. The pH of the hydrolyzed silane solution can be controlled to from about 4 to about 10, or from about 7 to about 8 to thereby result in photoconductor electrical stability. Control of the pH of the hydrolyzed silane solution may be affected with any suitable material, such as generally organic acids or inorganic acids. Examples of organic and inorganic acids selected for pH control include acetic acid, citric acid, formic acid, hydrogen iodide, phosphoric acid, hydrofluorosilicic acid, p-toluene sulfonic acid, and the like.

The hole blocking layer can, in embodiments, be prepared by a number of known methods, the process parameters being dependent, for example, on the photoconductor member desired. The hole blocking layer can be coated as a solution or a dispersion onto the photoconductor supporting substrate, or on to the ground plane layer by the use of a spray coater, dip coater, extrusion coater, roller coater, wire-bar coater, slot coater, doctor blade coater, gravure coater, and the like, and dried at from about 40° C. to about 200° C. or from 75° C. to 150° C. for a suitable period of time, such as from about 1 hour to about 4 hours, from about 1 minute to about 10 hours, or from about 40 minutes to about 100 minutes in the presence of an air flow. The hole blocking layer coating can be accomplished in a manner to provide a final hole blocking layer coating thickness after drying of, for example, from about 0.01 to about 30 microns, from about 0.02 to about 5 microns, or from about 0.03 to about 2 microns.

Adhesive Layer

An optional adhesive layer may be included between the hole blocking layer and the photogenerating layer. Typical adhesive layer materials selected for the photoconductors illustrated herein, include polyesters, polyurethanes, copolyesters, polyamides, poly(vinyl butyrals), poly(vinyl alcohols), polyacrylonitriles, and the like, and mixtures thereof. The adhesive layer thickness can be from about 0.001 to about 1 micron, from about 0.05 to about 0.5 micron, or from about 0.1 to about 0.3 micron. Optionally, the adhesive layer may contain effective suitable amounts of from about 1 to about 10 weight percent, or from about 1 to about 5 weight percent of conductive particles such as zinc oxide, titanium dioxide, silicon nitride, and carbon black, nonconductive particles, such as polyester polymers, and mixtures thereof.

Photogenerating Layer

Usually, the photogenerating layer is applied by vacuum deposition or by spray drying onto the supporting substrate, and a charge transport layer or plurality of charge transport layers are formed on the photogenerating layer. The charge transport layer may be situated on the photogenerating layer, the photogenerating layer may be situated on the charge transport layer, or when more than one charge transport layer is present, they can be contained on the photogenerating layer. Also, the photogenerating layer may be applied to layers that are situated between the supporting substrate and the charge transport layer.

Generally, the photogenerating layer can contain known photogenerating pigments, such as metal phthalocyanines, metal free phthalocyanines, alkylhydroxyl gallium phthalocyanines, hydroxygallium phthalocyanines, halogallium phthalocyanines, such as chlorogallium phthalocyanines, perylenes, such as bis(benzimidazo)perylene, titanyl phthalocyanines, especially Type V titanyl phthalocyanine, and the like, and mixtures thereof.

Examples of photogenerating pigments included in the photogenerating layer are vanadyl phthalocyanines, Type V hydroxygallium phthalocyanines, high sensitivity titanyl phthalocyanines, Type IV and V titanyl phthalocyanines, quinacridones, polycyclic pigments, such as dibromo anthanthrone pigments, perinone diamines, polynuclear aromatic quinones, azo pigments including bis-, tris- and tetrakis-azos, and the like and other known photogenerating pigments; inorganic components such as selenium, selenium alloys, and trigonal selenium; and pigments of crystalline selenium and its alloys.

The photogenerating pigment can be dispersed in a resin binder similar to the resin binders selected for the charge transport layer, or alternatively no resin binder need be present. For example, the photogenerating pigments can be present in an optional resinous binder composition in various amounts inclusive of up to 99.5 percent by weight based on the total weight of the photogenerating layer. Generally, from about 5 to about 95 percent by volume of the photogenerating pigment is dispersed in about 95 to about 5 percent by volume of a resinous binder, or from about 20 to about 30 percent by volume of the photogenerating pigment is dispersed in about 70 to about 80 percent by volume of the resinous binder composition. In one embodiment, about 90 percent by volume of the photogenerating pigment is dispersed in about 10 percent by volume of the resinous binder composition.

Examples of polymeric binder materials that can be selected as the matrix for the photogenerating layer pigments include thermoplastic and thermosetting resins, such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, poly(phenylene sulfides), poly(vinyl acetate), polysiloxanes, polyacrylates, polyvinyl acetals, polyamides, polyimides, amino resins, phenylene oxide resins, terephthalic acid resins, phenoxy resins, epoxy resins, phenolic resins, polystyrene, acrylonitrile copolymers, poly(vinyl chloride), vinyl chloride and vinyl acetate copolymers, acrylate copolymers, alkyd resins, cellulosic film formers, poly(amideimide), styrene butadiene copolymers, vinylidene chloride-vinyl chloride copolymers, vinyl acetate-vinylidene chloride copolymers, styrene-alkyd resins, poly(vinyl carbazole), and the like, inclusive of block, random, or alternating copolymers thereof.

It is often desirable to select a coating solvent for the photogenerating layer mixture, and which solvent does not substantially disturb or adversely affect the previously coated layers of the photoconductor. Examples of coating solvents used for the photogenerating layer coating mixture include ketones, alcohols, aromatic hydrocarbons, halogenated aliphatic hydrocarbons, ethers, amines, amides, esters, and the like, and mixtures thereof. Specific solvent examples selected for the photogenerating mixture are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

The photogenerating layer can be of a thickness of from about 0.01 to about 10 microns, from about 0.05 to about 10 microns, from about 0.2 to about 2 microns, or from about 0.25 to about 1 micron.

Charge Transport Layer

The charge transport layer or layers, and more specifically in embodiments, a first charge transport layer in contact with the photogenerating layer, and over the first charge transport layer a top or second charge transport overcoating layer, comprise a mixture of bis(enylaryl)arylamines and charge transporting compounds or molecules dissolved or molecularly dispersed in a film forming electrically inert polymer such as a polycarbonate. In embodiments, “dissolved” refers, for example, to forming a solution in which the charge transport molecules are dissolved in a polymer to form a homogeneous phase; and “molecularly dispersed” refers, for example, to charge transporting molecules or compounds dispersed on a molecular scale in a polymer.

In embodiments, charge transport refers, for example, to charge transporting molecules that allows the free charge generated in the photogenerating layer to be transported across the charge transport layer. The charge transport layer is usually substantially nonabsorbing to visible light or radiation in the region of intended use, but is electrically “active” in that it allows the injection of photogenerated holes from the photoconductive layer, or photogenerating layer, and allows these holes to be transported to selectively discharge a surface charge present on the surface of the photoconductor.

A number of charge transport compounds can be included in the charge transport layer or in at least one charge transport layer where at least one charge transport layer is from 1 to about 4 layers, from 1 to about 3 layers, 2 layers, or 1 layer. Examples of charge transport components or compounds present in an amount of from about 20 to about 80 weight percent, from about 30 to about 70 weight percent, or from about 40 to about 60 weight percent based on the total weight of the at least one charge transport layer are aryl amines selected from the group consisting of those represented by the following formulas/structures

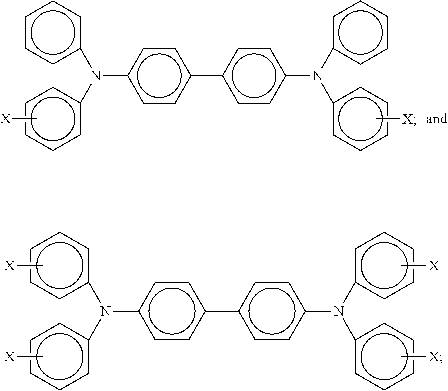

wherein X is a suitable hydrocarbon like alkyl, alkoxy, aryl, isomers thereof, and derivatives thereof like alkylaryl, alkoxyaryl, arylalkyl; a halogen, or mixtures of a suitable hydrocarbon and a halogen; and charge transport layer compounds as represented by the following formulas/structures

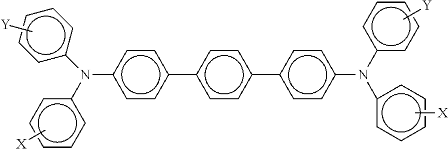

wherein X and Y are independently alkyl, alkoxy, aryl, a halogen, or mixtures thereof.

Alkyl and alkoxy for the photoconductor charge transport layer compounds illustrated herein contain, for example, from about 1 to about 25 carbon atoms, from about 1 to about 12 carbon atoms, or from about 1 to about 6 carbon atoms, such as methyl, ethyl, propyl, butyl, pentyl, hexyl, heptyl, octyl, nonyl, decyl, undecyl, dodecyl, pentadecyl, and the like, and the corresponding alkoxides. Aryl substituents for the charge transport layer compounds can contain from 6 to about 36, from 6 to about 24, from 6 to about 18, or from 6 to about 12 carbon atoms, such as phenyl, naphthyl, anthryl, and the like. Halogen substituents for the charge transport layer compounds include chloride, bromide, iodide, and fluoride. Substituted alkyls, substituted alkoxys, and substituted aryls can also be selected for the charge transport layer compounds.

Examples of specific aryl amines present in at least one photoconductor charge transport layer, in an amount of from about 20 to about 80 weight percent, from about 30 to about 70 weight percent, or from about 40 to about 60 weight percent, include N,N,N′,N′-tetra-p-tolyl-1,1′-biphenyl-4,4′-diamine, N,N′-diphenyl-N,N′-bis(alkylphenyl)-1,1′-biphenyl-4,4′-diamine wherein alkyl is selected from the group consisting of methyl, ethyl, propyl, butyl, hexyl, heptyl, octyl, nonyl, decyl, undecyl, dodecyl, pentadecyl, and the like; N,N′-diphenyl-N,N′-bis(halophenyl)-1,1′-biphenyl-4,4′-diamine wherein the halo substituent is chloro; N,N′-bis(4-butylphenyl)-N,N′-di-p-tolyl-[p-terphenyl]-4,4′-diamine, N,N′-bis(4-butylphenyl)-N,N′-di-m-tolyl-[p-terphenyl]-4,4′-diamine, N,N′-bis(4-butylphenyl)-N,N′-di-o-tolyl-[p-terphenyl]-4,4′-diamine, N,N′-bis(4-butylphenyl)-N,N′-bis-(4-isopropylphenyl)-[p-terphenyl]-4,4′-diamine, N,N′-bis(4-butylphenyl)-N,N′-bis-(2-ethyl-6-methylphenyl)-[p-terphenyl]-4,4′-diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4′-diamine, and the like; hydrazones such as N-phenyl-N-methyl-3-(9-ethyl)carbazyl hydrazone and 4-diethyl amino benzaldehyde-1,2-diphenyl hydrazone; and oxadiazoles such as 2,5-bis(4-N,N′-diethylaminophenyl)-1,2,4-oxadiazole, stilbenes, and the like.

A number of the charge transport compounds, such as N,N,N′,N′-tetra-p-tolyl-1,1′-biphenyl-4,4′-diamine, tend to crystallize in the charge transport layer due, it is believed, to their symmetric structure. The crystallization extent is dependent on the charge transport layer thickness; the thicker the charge transport layer, such as a thickness of about 25 to about 50 microns, the more severe is the crystallization of the N,N,N′,N′-tetra-p-tolyl-1,1′-biphenyl-4,4′-diamine.

Included in the charge transport layer of the photoconductors disclosed herein in addition to the above charge transport compound are bis(enylaryl)arylamines as represented by the following formulas/structures

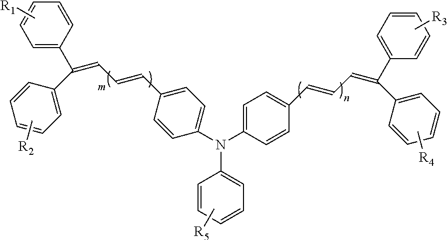

and which bis(enylaryl)arylamines can function to assist in the transport of charge. In the structures, each R is hydrogen, alkyl, alkoxy, aryl, substituted derivatives thereof, halo, and the like; and m and n each represents the number of segments, such as, for example, 0 to about 2.

Alkyl and alkoxy for the photoconductor bis(enylaryl)arylamine compounds illustrated herein contain, for example, from about 1 to about 25 carbon atoms, from about 1 to about 12 carbon atoms, or from about 1 to about 6 carbon atoms, such as methyl, ethyl, propyl, butyl, pentyl, hexyl, heptyl, octyl, nonyl, decyl, undecyl, dodecyl, pentadecyl, and the like, and the corresponding alkoxides. Aryl substituents for the bis(enylaryl)arylamines compounds can contain from 6 to about 36, from 6 to about 24, from 6 to about 18, or from 6 to about 12 carbon atoms, such as phenyl, naphthyl, anthryl, and the like. Halogen substituents for the bis(enylaryl)arylamine compounds include chloride, bromide, iodide, and fluoride. Substituted alkyls, substituted alkoxys, and substituted aryls can also be selected for the bis(enylaryl)arylamines compounds.

Examples of the charge transport layer bis(enylaryl)arylamines additives are bis(butadienylaryl)arylamines such as bis[4-(4,4-diphenyl-1,3-butadienyl)phenyl]phenylamine (T-651 available from Takasago Chemical Corp., Tokyo, Japan), and N,N-bis[4-[4,4-bis(4-methylphenyl)-1,3-butadienyl]phenyl]-4-methoxyphenylamine; (ethenylaryl)(butadienylaryl)arylamines such as [4-(2,2-diphenylethenyl)phenyl][4-(4,4-diphenyl-1,3-butadienyl)phenyl]phenylamine (available from Takasago Chemical Corp., Tokyo, Japan); and N,N-bis[4-(2,2-diphenylethenyl)phenyl]-4-methylphenylamine (T-736 available from Takasago Chemical Corp., Tokyo, Japan), N,N-bis[4-[2,2-bis(4-methylphenyl)ethenyl]phenyl]-4-methylphenylamine (T-925 available from Takasago Chemical Corp., Tokyo, Japan), and the like, and mixtures thereof.

In embodiments, the bis(enylaryl)arylamines additive contained in at least one charge transport layer, such as a first charge transport layer, a second charge transport layer, or both a first and second charge transport layer can be represented by the following formulas/structures

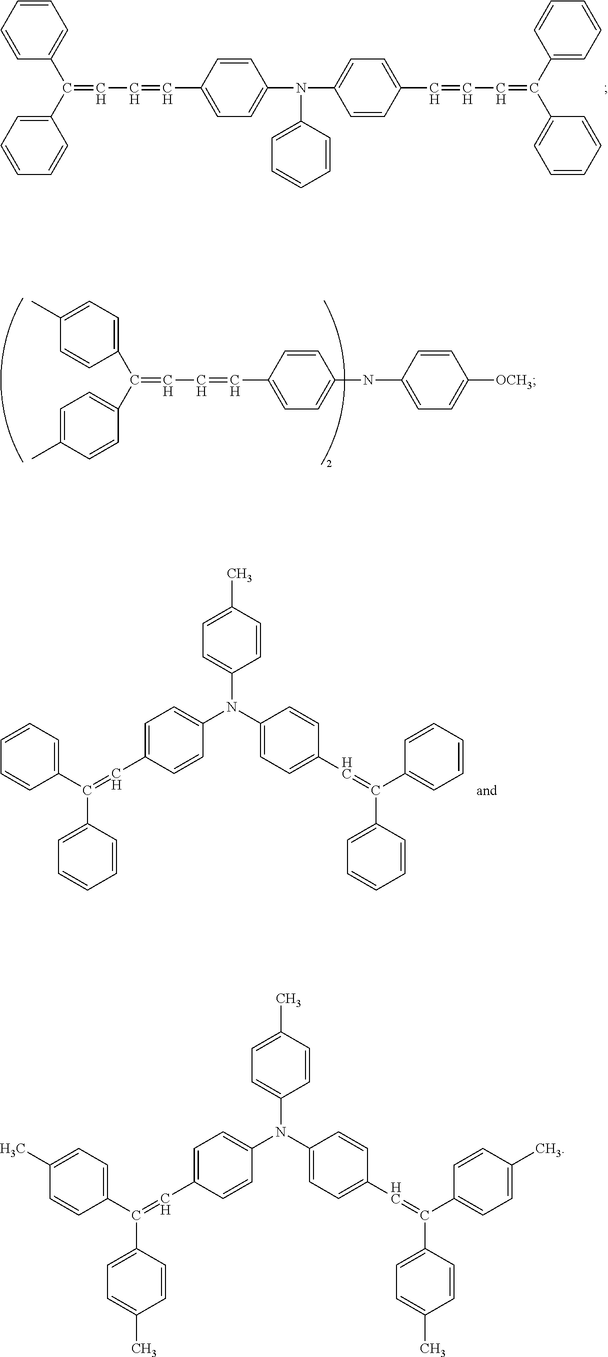

Examples of binders included in at least one charge transport layer in addition to the charge transport compound and the bis(enylaryl)arylamines additive, which additive is present in various amounts and ratios as illustrated herein include polycarbonates, polyarylates, acrylate polymers, vinyl polymers, cellulose polymers, polyesters, polysiloxanes, polyamides, polyurethanes, poly(cyclo olefins), epoxies, and random or alternating copolymers thereof; and more specifically, polycarbonates such as poly(4,4′-isopropylidene-diphenylene) carbonate (also referred to as bisphenol-A-polycarbonate), poly(4,4′-cyclohexylidine diphenylene) carbonate (also referred to as bisphenol-Z-polycarbonate), poly(4,4′-isopropylidene-3,3′-dimethyl-diphenyl) carbonate (also referred to as bisphenol-C-polycarbonate), and the like. In embodiments, electrically inactive binders that can be selected for the charge transport layer or charge transport layers are comprised of polycarbonate resins with a weight average molecular weight M_{w} of from about 20,000 to about 100,000, or of from about 50,000 to about 100,000.

The bis(enylaryl)arylamine can be present in the charge transport layer or in at least one charge transport layer in various effective amounts, such as from about 1 to about 50 weight percent, from about 2 to about 30 weight percent, or from about 3 to about 20 weight percent, based on the weight percent of the components in the charge transport layer of the bis(enylaryl)arylamine and the charge transport compound, and where the total amount of all components in the charge transport layer or at least one charge transport layer is about 100 weight percent.

The ratio of the binder, the charge transport compound, and the bis(enylaryl)arylamines present in the charge transport layer or in at least one charge transport layer can vary depending, for example, on the thicknesses of the photoconductor layers, and the properties desired. Typically, the ratio of the binder to the charge transport compound to the bis(enylaryl)arylamines additive, as primarily determined by the initial feed amounts of each, is about 55/40/10, about 60/30/10, about 63/3017, about 60/35/5, about 65/20/15, about 70/2515, or about 75/20/5, or values in between these amounts.

A number of processes may be used to mix, and thereafter apply the charge transport layer or layers coating mixture to the photogenerating layer. Typical application techniques include spraying, dip coating, roll coating, wire wound rod coating, and the like. Drying of the charge transport deposited layer coating or layer coatings may be affected by any suitable conventional technique such as oven drying, infrared radiation drying, air drying, and the like.

The thickness of the charge transport layer or charge transport layers, in embodiments, is from about 5 or about 10 to about 70 microns, from about 20 to about 65 microns, from about 15 to about 50 microns, or from about 10 to about 40 microns, but thicknesses outside this range may, in embodiments, also be selected. The charge transport layer should be an insulator to the extent that an electrostatic charge placed on the charge transport layer is not conducted in the absence of illumination at a rate sufficient to prevent formation and retention of an electrostatic latent image thereon. In general, the ratio of the thickness of the charge transport layer to the photogenerating layer can be from about 2:1 to 200:1, and in some instances about 400:1.

Examples of components or materials optionally incorporated into at least one charge transport layer to, for example, enable excellent lateral charge migration (LCM) resistance include hindered phenolic antioxidants, such as tetrakis methylene(3,5-di-tert-butyl-4-hydroxy hydrocinnamate) methane (IRGANOX™ 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX™ 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd. Of Japan), TINUVIN™ 144 and 622LD (available from Ciba Specialties Chemicals), MARK™ LA57, LA67, LA62, LA68 and LA63 (available from Asahi Denka Co., Ltd.), and SUMILIZER™ TPS (available from Sumitomo Chemical Co., Ltd.); thioether antioxidants such as SUMILIZER™ TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layers is from about 0 to about 20 weight percent, from about 1 to about 10 weight percent, or from about 3 to about 8 weight percent based upon about 100 weight percent of all the components in the charge transport layer.

Overcoat Layer

The overcoat layer in contact with the top charge transport layer comprises a charge transport component or a charge transport compound, such as those illustrated herein, and a melamine resin. One exemplary charge transport compound selected for the overcoat layer is N,N′-diphenyl-N,N-diphenyl-N,N′-bis(3-hydroxyphenyl)-[1,1′-biphenyl]-4,4′-diamine. The overcoat layer can be prepared by combining in solution a melamine resin, an acid catalyst, and the charge transport component.

In various embodiments, the melamine resin selected for the photoconductor overcoat layer can be represented by the following formulas/structures

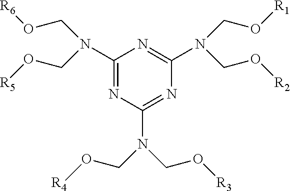

wherein R₁, R₂, R₃, R₄, R₅ and R₆ each independently represent at least one of a hydrogen atom, and alkyl with, for example, from 1 to about 12 carbon atoms, from 1 to about 8 carbon atoms, and more specifically, from 1 to about 4 carbon atoms, examples of specific alkyl substituents being illustrated herein such as methyl, ethyl, propyl, butyl, pentyl, hexyl, heptyl, octyl, nonyl, decyl, undecyl, dodecyl, pentadecyl, and the like.

Examples of melamine resins selected for the photoconductor overcoat layer include highly methylated/butylated melamine formaldehyde resins, such as those commercially available from Cytec Industries, as CYMEL® 303, 104, MM-100, and the like. These melamine formaldehyde resins, which are water-soluble, dispersible or nondispersible, exhibit a high, such as about 75 to about 95 percent, from about 80 to about 95 percent, from about 75 to about 90 percent, or from about 85 to about 90 percent of alkylation.

The methoxymethylated melamine resin CYMEL® 303, available from Cytec Industries as (CH₃OCH₂)₆N₃C₃N₃), and selected for the overcoat layer is represented by the following formula/structure

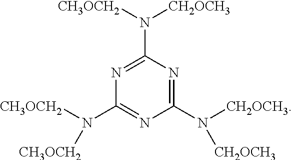

Specific examples of melamine resins present in the overcoat layer include highly, for example, from about 75 to about 95 percent, from 80 to about 95 percent, from about 75 to about 90 percent, or from about 85 to about 90 alkylation percentage for the alkylated/alkoxylated, partially, such as from about 40 to about 65 percent of alkylated/alkoxylated, or mixed alkylated/alkoxylated resins; methylated, n-butylated or isobutylated resins; highly methylated melamine resins such as CYMEL® 350, 9370; methylated imino melamine resins (partially methylolated and highly alkylated) such as CYMEL® 323, 327; partially methylated melamine resins (highly methylolated and partially methylated) such as CYMEL® 373, 370; high solids mixed ether melamine resins such as CYMEL® 1130, 324; n-butylated melamine resins such as CYMEL® 1151, 615; n-butylated high imino melamine resins such as CYMEL® 1158; and iso-butylated melamine resins such as CYMEL® 255-10. CYMEL® melamine resins are commercially available from CYTEC Industries, Inc. More specifically, the melamine resin may be selected from the group consisting of methylated melamine resins, methoxymethylated melamine resins, ethoxymethylated melamine resins, propoxymethylated melamine resins, butoxymethylated melamine resins, hexamethylol melamine resins, alkoxyalkylated melamine resins such as methoxymethylated melamine resin, ethoxymethylated melamine resin, propoxymethylated melamine resin, butoxymethylated melamine resin, and mixtures thereof.

The melamine resin, which can function as a crosslinking agent, is present in the photoconductor overcoat layer mixture in an amount of from about 20 to about 80 weight percent, from about 30 to about 70 weight percent, or from about 40 to about 60 weight percent based on the based on the total weight of the overcoat layer. The ratio of charge transport compound to the melamine resin can be from about 20/80 to about 80/20, from about 30/70 to about 70/30, from about 40/60 to about 60/40, or about 50/50. While not being desired to be limited by theory, it is believed that the crosslinking percentage of the overcoat layer components is from about 77 to about 99 percent, from about 80 to about 95 percent, or from about 70 to about 90 percent as determined by known methods, such as determined with Fourier Transform Infrared Spectroscopy (FTIR).

The crosslinking reaction of the melamine resin and the charge transport material can be catalyzed with a strong acid catalyst. Examples of strong acid catalysts include p-toluene sulfonic acid, commercially available acid catalysts available from CYCAT® such as CYCAT® 600, CYCAT® 4040, and the like. In embodiments, the catalyst is added to the overcoat layer mixture components in an amount of from about 0.1 to about 5 weight percent, from about 0.3 to about 3 weight percent, or from about 0.4 to about 1 weight percent.

In embodiments, the charge transport component or compound selected for the photoconductor overcoat layer is a crosslinkable alcohol soluble compound represented by

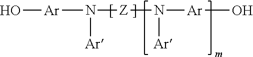

wherein m represents the number of segments and is, for example, zero or 1; Z is selected from the group consisting of at least one of

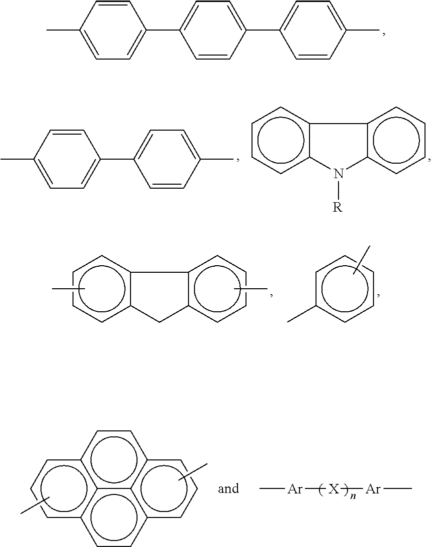

wherein n represents the number of X substituents, such as 0 or 1; Ar is selected from the group consisting of at least one of

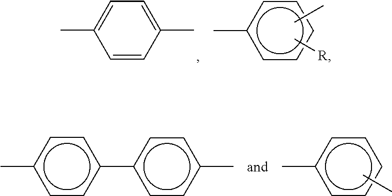

where R is selected from the group consisting of at least one of alkyl like methyl, ethyl, propyl, butyl, pentyl, and the like; Ar′ is selected from the group consisting of at least one of

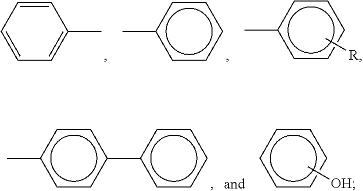

and X is selected from the group consisting of at least one of

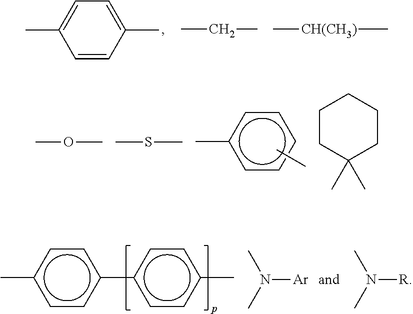

wherein p represents the number of segments and is, for example, zero, 1, or 2; R is alkyl, and Ar is selected from the group consisting of at least one of the substituents represented by the following formulas/structures

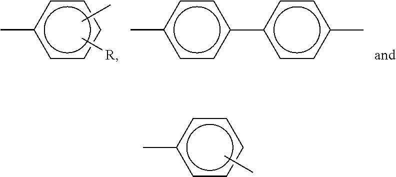

wherein R is alkyl

Examples of charge transport compounds present in the overcoat layer are hydroxyl aryl amines represented by

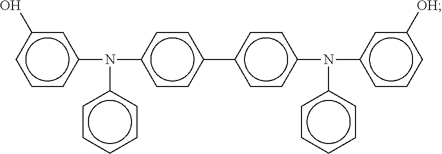

dihydroxyaryl terphenylamines represented by

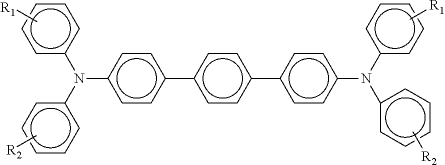

wherein each R₁ and R₂ is independently selected from the group consisting of at least one of a hydrogen atom, a hydroxy group, a group represented by —CₙH₂ₙ₊₁ where n is from 1 to about 12 or from 1 to about 6, aralkyl, and aryl groups with from about 6 to about 36 carbon atoms, from about 6 to about 24 carbon atoms, from 6 to about 18 carbon atoms, or from 6 to about 12 carbon atoms, and mixtures of hydroxyl aryl amines and dihydroxyaryl terphenylamines.

The overcoat layer, in embodiments of the present disclosure, can be prepared by coating a solution of a solvent like an alcohol, the melamine resin, the acid catalyst, and the charge transport compound, heating to a temperature of from about 120° C. to about 200° C. for a period of from about 30 minutes to about 120 minutes, and allowing the resulting mixture to cool to room temperature (about 25° C.). Any suitable solvent, such as a primary, secondary or tertiary alcohol solvent, can be employed for the deposition of the film forming overcoat layer. Typical alcohol solvents include, but are not limited to, tert-butanol, sec-butanol, n-butanol, 2-propanol, 1-methoxy-2-propanol, and the like, and mixtures thereof. There may also be selected as deposition solvents for the forming of the overcoat layer tetrahydrofuran, monochlorobenzene, methylene chloride, toluene, xylene and mixtures thereof.

There may also be included in the overcoat layer low surface energy components, such as hydroxyl terminated fluorinated additives, hydroxyl silicone modified polyacrylates, and mixtures thereof. Examples of the low surface energy components, present in various effective amounts, such as from about 0.1 to about 10 weight percent, from about 0.5 to about 5 weight percent, or from about 1 to about 3 weight percent, based on the total weight of the overcoat layer, are hydroxyl derivatives of perfluoropolyoxyalkanes such as FLUOROLINK® D (M.W. about 1,000 and fluorine content about 62 percent), FLUOROLINK® D10-H (M.W. about 700 and fluorine content about 61 percent), and FLUOROLINK® D10 (M.W. about 500 and fluorine content about 60 percent) (functional group —CH₂OH); FLUOROLINK® E (M.W. about 1,000 and fluorine content about 58 percent) and FLUOROLINK® E10 (M.W. about 500 and fluorine content about 56 percent) (functional group —CH₂(OCH₂CH₂)ₙOH); FLUOROLINK® T (weight average molecular weight, M.W. about 550 and fluorine content about 58 percent) and FLUOROLINK® T10 (M.W. about 330 and fluorine content about 55 percent) (functional group —CH₂OCH₂CH(OH)CH₂OH); and hydroxyl derivatives of perfluoroalkanes (R_{f}CH₂CH₂OH, wherein R_{f}═F(CF₂CF₂)ₙ) such as ZONYL® BA (M.W. about 460 and fluorine content about 71 percent), ZONYL® BA-L (M.W. about 440 and fluorine content about 70 percent), ZONYL® BA-LD (M.W. about 420 and fluorine content about 70 percent), and ZONYL® BA-N (M.W. about 530 and fluorine content about 71 percent); carboxylic acid derivatives of fluoropolyethers such as FLUOROLINK® C (M.W. about 1,000 and fluorine content about 61 percent), carboxylic ester derivatives of fluoropolyethers such as FLUOROLINK® L (M.W. about 1,000 and fluorine content about 60 percent), FLUOROLINK® L10 (M.W. about 500 and fluorine content about 58 percent), carboxylic ester derivatives of perfluoroalkanes (R_{f}CH₂CH₂O(C═O)R, wherein R_{f}═F(CF₂CF₂)ₙ and R is alkyl) such as ZONYL® TA-N (fluoroalkyl acrylate, R═CH₂═CH—, M.W. about 570 and fluorine content about 64 percent), ZONYL® TM (fluoroalkyl methacrylate, R═CH₂═C(CH₃)—, M.W. about 530 and fluorine content about 60 percent), ZONYL® FTS (fluoroalkyl stearate, R═C₁₇H₃₅—, M.W. about 700 and fluorine content about 47 percent), ZONYL® TBC (fluoroalkyl citrate, M.W. about 1,560 and fluorine content about 63 percent), sulfonic acid derivatives of perfluoroalkanes (R_{f}CH₂CH₂SO₃H, wherein R_{f}═F(CF₂CF₂)ₙ) such as ZONYL® TBS (M.W. about 530 and fluorine content about 62 percent); ethoxysilane derivatives of fluoropolyethers such as FLUOROLINK® S10 (M.W. about 1,750 to 1,950); phosphate derivatives of fluoropolyethers such as FLUOROLINK® F10 (M.W. about 2,400 to 3,100); hydroxyl derivatives of silicone modified polyacrylates such as BYK-SILCLEAN® 3700; polyether modified acryl polydimethylsiloxanes such as BYK-SILCLEAN® 3710; and polyether modified hydroxyl polydimethylsiloxanes such as BYK-SILCLEAN® 3720. FLUOROLINK® is a trademark of Ausimont, Inc., ZONYL® is a trademark of E.I. DuPont, and BYK-SILCLEAN® is a trademark of BYK SILCLEAN.

The thickness of the overcoat layer as measured with a Permascope is from about 1 to about 20 microns, from about 1 to about 15 microns, from about 1 to about 10 microns, or from about 1 to about 5 microns. Typical application techniques for applying the overcoat layer over the outermost charge transport layer can include spraying, dip coating, roll coating, wire wound rod coating, extrusion coating, flow coating, and the like. Drying of the deposited overcoat layer can be effected by any suitable conventional technique such as oven drying, infrared radiation drying, air drying, and the like.

Weight percent is as illustrated herein and, in embodiments, is based, for example, on the weight of all the components in the layers disclosed or the amount of solids in the layers disclosed.

Also included within the scope of the present disclosure are methods of imaging and printing with the photoconductors illustrated herein. These methods generally involve the formation of an electrostatic latent image on the imaging member, followed by developing the image with a toner composition comprised, for example, of thermoplastic resin, colorant, such as pigment, charge additive, and surface additive, subsequently transferring the toner image to a suitable image receiving substrate, and permanently affixing the image thereto. In those environments wherein the photoconductor is to be used in a printing mode, the imaging method involves the same operation with the exception that exposure can be accomplished with a laser device or image bar. More specifically, the flexible photoconductors disclosed herein can be selected for the Xerox Corporation iGEN® machines that generate with some versions over 100 copies per minute. Processes of imaging, especially xerographic imaging and printing, including digital and/or color printing are thus encompassed by the present disclosure. The imaging members are, in embodiments, sensitive in the wavelength region of, for example, from about 400 to about 900 nanometers, and from about 650 to about 850 nanometers, thus diode lasers can be selected as the light source. Moreover, the imaging members of this disclosure are useful in color xerographic applications, particularly high-speed color copying and printing processes inclusive of digital xerographic processes.

The thicknesses of each of the photoconductor layers illustrated herein were determined by known analytical methods and more specifically by the use of a Permascope. The molecular weights of the components and compounds illustrated herein were determined by Gel Permeation Chromatography (GPC).

The following Examples are being submitted to illustrate embodiments of the present disclosure. These Examples are intended to be illustrative only, and are not intended to limit the scope of the present disclosure. Also, parts and percentages are by weight unless otherwise indicated. The thicknesses of each layer were measured by a Permascope. Comparative Examples and data are also provided.

### COMPARATIVE EXAMPLE 1

Zirconium acetylacetonate tributoxide (35.5 parts), γ-aminopropyl triethoxysilane (4.8 parts), and poly(vinyl butyral) BM-S (2.5 parts) were dissolved in n-butanol (52.2 parts). The resulting coating solution layer was preheated at 59° C. for 13 minutes, humidified at 58° C. (dew point=54° C.) for 17 minutes, and dried at 135° C. for 8 minutes. Subsequently, the obtained undercoat layer solution was coated by a dip coater on a 30 millimeter thick aluminum drum substrate. The thickness of the resulting undercoat layer was approximately 1.3 microns.

A photogenerating layer of a thickness of about 0.2 micron comprising a hydroxygallium phthalocyanine Type V dispersion was deposited by spraying on the above 1.3 micron thick undercoat layer. The photogenerating layer coating dispersion was prepared as follows. Three grams of the hydroxygallium phthalocyanine Type V pigment were mixed with 2 grams of a polymeric binder of a carboxyl-modified vinyl copolymer, VMCH, available from Dow Chemical Company, and 45 grams of n-butyl acetate. The resulting mixture was milled in an Attritor mill with about 200 grams of 1 millimeter Hi-Bea borosilicate glass beads for about 3 hours. The dispersion obtained was filtered through a 20 micron Nylon cloth filter, and the solid content of the dispersion was diluted to about 6 weight percent.

Subsequently, a 24 micron thick charge transport layer was coated on top of the photogenerating layer from a solution prepared from mixing N,N′-diphenyl-N,N-bis(3-methylphenyl)-1,1′-biphenyl-4,4′-diamine (5 grams) and a film forming polymer binder PCZ-400 (poly(4,4′-dihydroxy-diphenyl-1-1-cyclohexane, weight average molecular weight, M_{w} of 40,000)) obtained from Mitsubishi Gas Chemical Company, Ltd. (7.5 grams) in a solvent mixture of 30 grams of tetrahydrofuran (THF) and 10 grams of monochlorobenzene (MCB). The charge transport layer was dried at about 120° C. for about 20 minutes.

An overcoat layer solution was then applied to the formed charge transport layer by spraying, and which solution was formed by mixing and heating 8.3 grams of the melamine resin CYMEL® 303 (a methylated/butylated melamine-formaldehyde resin obtained from Cytec Industries Inc.), 9.7 grams of the charge transport compound N,N′-diphenyl-N,N′-bis(3-hydroxyphenyl)-[1,1′-biphenyl]-4,4′-diamine, 0.72 gram of BYK-SILCLEAN® 3700 (a low surface energy hydroxylated silicone modified polyacrylate obtained from BYK-Chemie USA), and 0.9 gram of NACURE® XP357 (a blocked acid catalyst obtained from King Industries) in 72 grams of DOWANOL® PM (1-methoxy-2-propanol obtained from the Dow Chemical Company). The resultant overcoat layer was dried in a forced air oven for 40 minutes at 155° C. to yield a highly, about 95 percent, crosslinked, 4.5 micron thick overcoat layer, and which overcoat layer was substantially insoluble in methanol or ethanol.

The ratio of PCZ-400 to N,N′-diphenyl-N,N-bis(3-methylphenyl)-1,1′-biphenyl-4,4′-diamine in the charge transport layer was 60/40; and the ratio of N,N′-diphenyl-N,N′-bis(3-hydroxyphenyl)-[1,1′-biphenyl]-4,4′-diamine to the melamine resin/acid catalyst/low surface energy component in the overcoat layer was 45.2/52.8/111.

### EXAMPLE I

A photoconductor was prepared by repeating the process of Comparative Example 1 except that the charge transport layer solution was prepared by mixing N,N,N′,N′-tetra-p-tolyl-1,1′-biphenyl-4,4′-diamine (3.75 grams), bis[4-(4,4-diphenyl-1,3-butadienyl)phenyl]phenylamine (available as T-651 from Takasago Chemical Corp., Tokyo, Japan, 1.25 grams), and a film forming polymer binder PCZ-400 a (poly(4,4′-dihydroxy-diphenyl-1-1-cyclohexane, weight average molecular weight, M_{w} of 40,000)), as obtained from Mitsubishi Gas Chemical Company, Ltd. (7.5 grams) in a solvent mixture of 30 grams of tetrahydrofuran (THF) and 10 grams of monochlorobenzene (MCB).

The ratio, as determined by initial feed of PCZ-400 to N,N,N′,N′-tetra-p-tolyl-1,1′-biphenyl-4,4′-diamine to bis[4-(4,4-diphenyl-1,3-butadienyl)phenyl]phenylamine in the charge transport layer was 60/30/10.

There was visually observed no N,N,N′,N′-tetra-p-tolyl-1,1-biphenyl-4,4′-diamine crystallization for the Example I photoconductor as compared to a crystallization of 40 percent for the N,N,N′,N′-tetra-p-tolyl-1,1′-biphenyl-4,4′-diamine when it was combined with only the above PCZ-400 film forming binder and no bis[4-(4,4-diphenyl-1,3-butadienyl)phenyl]phenylamine was present. Crystallization caused significantly slower hole transport.

### EXAMPLE II

A number of photoconductors are prepared by repeating the process of Example I except that there is selected in place of the bis[4-(4,4-diphenyl-1,3-butadienyl)phenyl]phenylamine, N,N-bis[4-[4,4-bis(4-methylphenyl)-1,3-butadienyl]phenyl]-4-methoxyphenylamine, [4-(2,2-diphenylethenyl)phenyl][4-(4,4-diphenyl-1,3-butadienyl)phenyl]phenylamine, N,N-bis[4-(2,2-diphenylethenyl)phenyl]-4-methylphenylamine (T-736 available from Takasago Chemical Corp., Tokyo, Japan), or N,N-bis[4-[2,2-bis(4-methylphenyl)ethenyl]phenyl]-4-methylphenylamine (T-925 available from Takasago Chemical Corp., Tokyo, Japan).

### Electrical Property Testing

The above prepared Comparative Example 1 and Example I photoconductors, each with a 24 micron thick charge transport layer and 4.5 micron overcoat layer, were tested in a scanner set to obtain photoinduced discharge cycles, sequenced at one charge-erase cycle followed by one charge-expose-erase cycle, wherein the light intensity was incrementally increased with cycling and surface potentials at various exposure intensities were measured. The scanner was equipped with a scorotron set to a constant voltage charging at various surface potentials. The photoconductors were scanned at 120 rpm 50 ms after exposure, and the results are shown below in Table 1, where V_{L} represents the residual potential.

TABLE 1

| | | A Zone | B Zone | C Zone |
|---|---|---|---|---|
| Example I Photoconductor | V_{L} | 91 V | 109 V | 156 V |
| (PCZ-400/N,N,N′,N′-tetra-p-tolyl-1,1′- | Dark | 18 V | 20 V | 22 V |
| biphenyl-4,4′-diamine/T-651 = 60/30/10) | Decay | | | |
| Comparative Example 1 Photoconductor | V_{L} | 120 V | 140 V | 201 V |
| (PCZ-400/N,N′-diphenyl-N,N′-bis(3- | Dark | 18 V | 21 V | 25 V |
| hydroxyphenyl)-[1,1′-biphenyl]-4,4′- | Decay | | | |
| diamine = 60/40) | | | | |

Table 1 demonstrates that the disclosed photoconductor of Example I exhibited about 50V lower C zone V_{L} than that of the Comparative Example photoconductor, with no negative impacts on the other key properties of the Example I photoconductor such as dark decay in A, B, and C zones. Lower V_{L} in C zone indicates that the photoconductor of Example I possessed a cyclic stability of about 40 percent greater than the Comparative Example 1 photoconductor.

### Ghosting Measurements

Ghosting refers, for example, to when a photoconductor is selectively exposed to positive charges in a number of xerographic print engines, and where some of the positive charges enter the photoconductor and manifest themselves as a latent image in the subsequent printing cycles. This print defect can cause a change in the lightness of the half tones, and is commonly referred to as a “ghost” that is generated in the previous printing cycle. An example of a source of the positive charges is the stream of positive ions emitted from the transfer corotron. Because the paper sheets are situated between the transfer corotron and the photoconductor, the photoconductor is shielded from the positive ions by the paper sheets. In the areas between the paper sheets, the photoconductor is fully exposed, thus in this paper free zone the positive charges may enter the photoconductor. As a result, these charges cause a print defect or ghost in a half tone print if one switches to a larger paper format that covers the previous paper print free zone.

The Comparative Example 1 and the Example I photoconductors were acclimated at room temperature, about 25° C., for 24 hours before testing in A zone (80° F. and 80 percent humidity) and in J zone (70° F. and 10 percent humidity) for ghosting. Print testing was accomplished in the Xerox Corporation WorkCentre™ Pro C3545 using the K (black toner) station at t of 500 print counts (t equal to 500 is the 500^{th} print), and the CMY stations of the color WorkCentre™ Pro C3545, which operated from t of 0 to t of 500 print counts.

The above generated xerographic prints for determining ghosting characteristics includes an X symbol or letter on a half toned image. When X is invisible, the ghost level is assigned Grade 0; when X is barely visible, the ghost level is assigned Grade 1; Grade 2 to Grade 5 refers to the level of visibility of X with Grade 5 meaning a dark and visible X. Ghosting levels were visually measured against an empirical scale, the smaller the ghosting grade (absolute value), the better the print quality. A negative ghosting grade number, such as −2.5 in A zone and −1 in J zone for Example I, translates into improved and excellent ghosting characteristics vs. the photoconductor of Comparative Example 1 with grades of −4 and −2.5.

The Table 2 data below demonstrates that the Example I photoconductor exhibited lower ghosting characteristics vs. the Comparative Example 1 photoconductor.

TABLE 2

| | A Zone | J Zone |
|---|---|---|
| | Ghosting | Ghosting |
| Photoconductor | T = 500 prints | T = 500 prints |
| Comparative Example 1 photoconductor | Grade −4 | Grade −2.5 |
| (PCZ-400/N,N′-diphenyl-N,N′-bis(3- | | |
| hydroxyphenyl)-[1,1′-biphenyl]-4,4′- | | |
| diamine = 60/40) | | |
| Example I photoconductor | Grade −2.5 | Grade −1 |
| (PCZ-400/ N,N,N′,N′-tetra-p-tolyl-1,1′- | | |
| biphenyl-4,4′-diamine/T-651 = | | |
| 60/30/10) | | |

### Cyclic Stability Testing

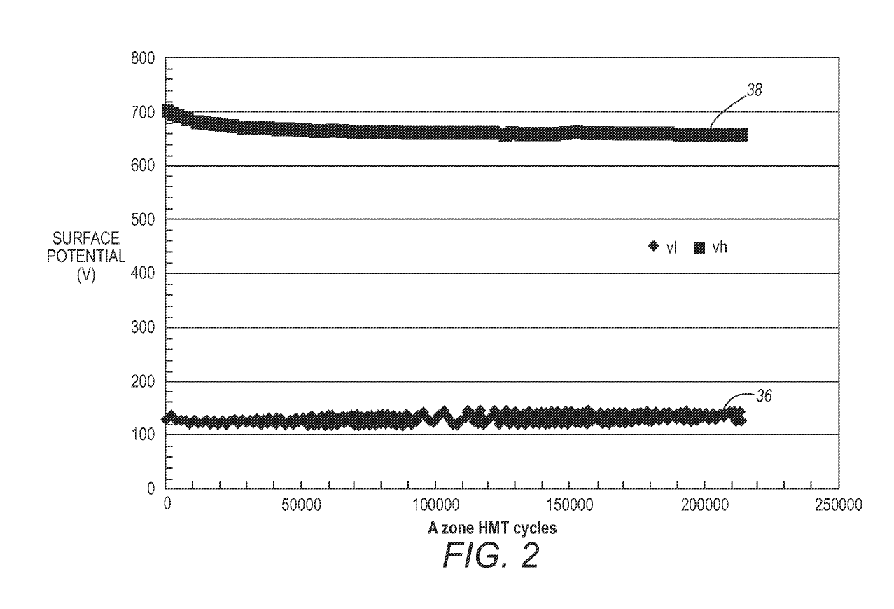

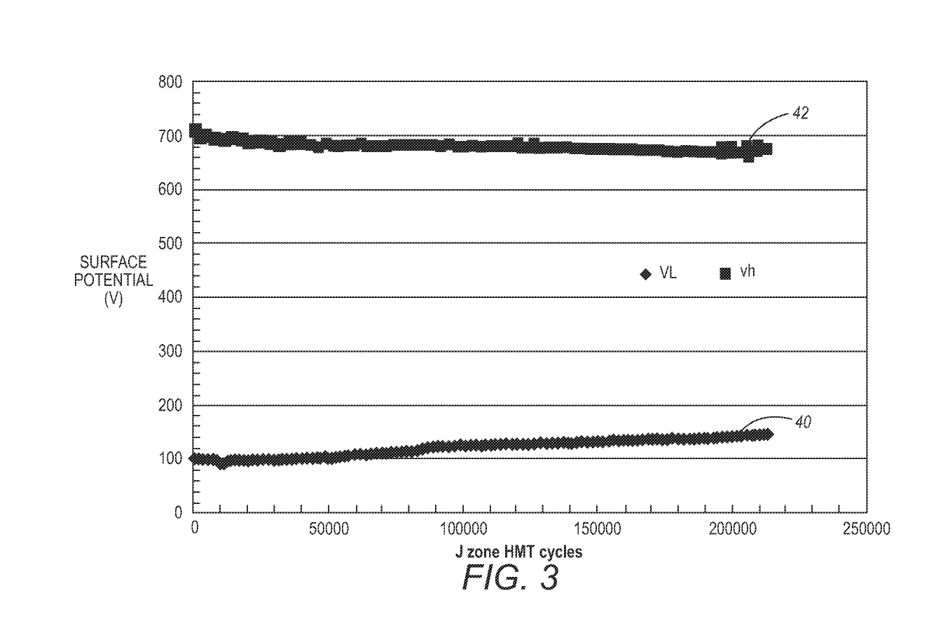

The above-prepared photoconductor of Example I was tested for cyclic stability by using an in-house high-speed Hyper Mode Test (HMT). The HMT fixture rotated the drum photoconductor of Example I at 150 rpm under a Scoroton set to −700 volts than the drum was exposed to a LED erase lamp. Two voltage probes were positioned 90 degrees apart to measure V_{high} (V_{H}) and V_{residual} (V_{L}) with nonstop 250,000 cycles of charge/discharge/erase cycling. The ozone that was produced during cycling was evacuated by an air pump and an ozone filter to simulate a more realistic machine printing environment. The HMT cycling results are shown by the graphs of FIGS. 2 and 3, and the data of Tables 3 and 4, which demonstrate that both V_{H} and V_{L} of the disclosed photoconductor of Example I possessed excellent long term cyclic stability.

TABLE 3

| A Zone HMT | | | | | |
|---|---|---|---|---|---|
| Cycles | | 150 | 50,000 | 100,000 | 200,000 |
| Example I | V_{H} (V) | 706 | 668 | 663 | 658 |
| | V_{L} (V) | 128 | 121 | 128 | 137 |

TABLE 4

| J Zone HMT | | | | | |
|---|---|---|---|---|---|
| Cycles | | 150 | 50,000 | 100,000 | 200,000 |
| Example I | V_{H} (V) | 722 | 704 | 683 | 676 |
| | V_{L} (V) | 134 | 134 | 143 | 160 |

In FIG. 2 there is illustrated a graph of the surface potentials of the overcoated photoconductor of Example I designated as line 36 for V_{L}, and designated as line 38 for V_{H}. This graph illustrates the surface potentials in volts of from 0 to 800 versus A zone (80 percent relative humidity and 80° F.) HMT cycles (photoconductor cyclic stability) of from 0 to 250,000, using a known in-house high-speed Hyper Mode Test (HMT). The HMT fixture rotated the drum photoconductor of Example I at 150 rpm under a Scoroton set to −700 volts. The drum photoconductor was then exposed to a LED erase lamp. Two voltage probes were positioned 90 degrees apart to measure V_{high} (V_{H}) and V_{residual} (V_{L}) starting at zero cycles up to a continuous 250,000 xerographic simulated cycles of charge/discharge/erase. The ozone that was produced during cycling was evacuated by an air pump and an ozone filter to simulate a realistic xerographic machine printing environment.

In FIG. 3 there is illustrated a graph of the surface potentials of the overcoated photoconductor of Example I, designated as line 40 for V_{L} and designated as line 42 for V_{H}. This graph illustrates the surface potentials in volts of from 0 to 800 versus the J zone (10 percent relative humidity and 70° F.) HMT cycles (photoconductor cyclic stability) of from 0 to 250,000 xerographic cycles, using a known in-house high-speed Hyper Mode Test (HMT). The HMT fixture rotated the drum photoconductor of Example I at 150 rpm under a Scoroton set to −700 volts. The drum photoconductor was then exposed to a LED erase lamp. Two voltage probes were positioned 90 degrees apart to measure V_{high} (V_{H}) and V_{residual} (V_{L}) starting at zero and up to a continuous 250,000 xerographic simulated cycles of charge/discharge/erase. The ozone generated during xerographic cycling was evacuated by an air pump and an ozone filter to simulate xerographic machine printing environments.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A photoconductor comprising a supporting substrate, an optional hole blocking layer, an optional adhesive layer, a photogenerating layer, a charge transport layer comprising a mixture of a charge transport compound and a bis(enylaryl)arylamine, and an overcoat layer comprising a charge transport compound and a melamine resin.

2. A photoconductor in accordance with claim 1 wherein said bis(enylaryl)arylamine is present in an amount of from about 1 to about 50 weight percent based on the total weight of the charge transport layer components.

3. A photoconductor in accordance with claim 1 wherein said charge transport layer further includes a resin binder, and wherein the ratio of the resin binder to said charge transport compound to said bis(enylaryl)arylamine is from about 60/30/10 to about 7512015.

4. A photoconductor in accordance with claim 1 wherein said bis(enylaryl)arylamine is represented by the following formulas/structures 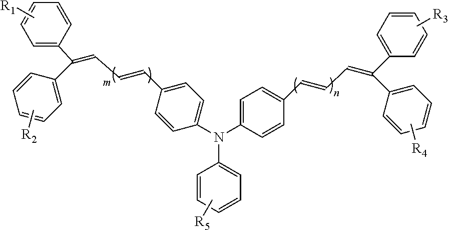
wherein each R₁, R₂, R₃, R₄ and R₅ is independently hydrogen, alkyl, alkoxy, aryl, and halo; and m and n each represents the number of repeating segments.

5. A photoconductor in accordance with claim 1 wherein said bis(enylaryl)arylamine is bis[4-(4,4-diphenyl-1,3-butadienyl)phenyl]phenylamine, N,N-bis[4-[4,4-bis(4-methylphenyl)-1,3-butadienyl]phenyl]-4-methoxyphenylamine, [4-(2,2-diphenylethenyl)phenyl][4-(4,4-diphenyl-1,3-butadienyl)phenyl]phenylamine, N,N-bis[4-(2,2-diphenylethenyl)phenyl]-4-methylphenylamine, N,N-bis[4-[2,2-bis(4-methylphenyl)ethenyl]phenyl]-4-methylphenylamine, or mixtures thereof,

6. A photoconductor in accordance with claim 1 wherein said bis(enylaryl)arylamine is a bis(butadienylaryl)arylamine.

7. A photoconductor in accordance with claim 1 wherein said charge transport compound for said charge transport layer is represented by the following alternative formulas/structures 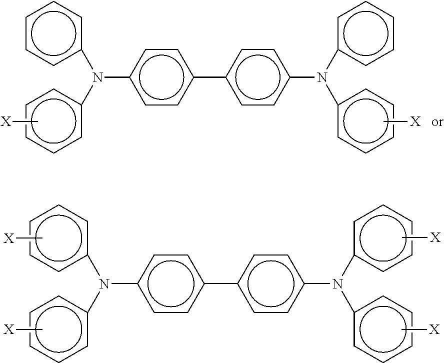
wherein X is selected from the group consisting of alkyl, alkoxy, aryl, halogen, and mixtures thereof.

8. A photoconductor in accordance with claim 1 wherein said charge transport compound for said charge transport layer is represented by the following formulas/structures 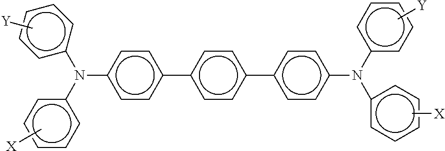
wherein each X and Y is independently selected from the group consisting of at least one of alkyl, alkoxy, aryl, and halogen.

9. A photoconductor in accordance with claim 1 wherein said charge transport compound for said charge transport layer compound is selected from the group consisting of N,N,N′,N′-tetra-p-tolyl-1,1′-biphenyl-4,4′-diamine, diphenyl-N,N-bis(3-methylphenyl)-1,1′-biphenyl-4,4′-diamine, N,N′-bis(4-butylphenyl)-N,N′-di-p-tolyl-[p-terphenyl]-4,4′-diamine, N,N′-bis(4-butylphenyl)-N,N′-di-m-tolyl-[p-terphenyl]-4,4′-diamine, N,N′-bis(4-butylphenyl)-N,N′-di-o-tolyl-[p-terphenyl]-4,4′-diamine, N,N′-bis(4-butylphenyl)-N,N′-bis-(4-isopropylphenyl)-[p-terphenyl]-4,4′-diamine, N,N′-bis(4-butylphenyl)-N,N′-bis-(2-ethyl-6-methylphenyl)-[p-terphenyl]-4,4′-diamine, N,N′-bis(4-butylphenyl)-N,N′-bis-(2,5-dimethylphenyl)-[p-terphenyl]-4,4′-diamine, and N,N′-diphenyl-N,N′-bis(3-chlorophenyl)-[p-terphenyl]-4,4′-diamine.

10. A photoconductor in accordance with claim 1 wherein said charge transport layer is comprised of a top charge transport layer and a bottom charge transport layer, and wherein said bottom charge transport layer is situated between said photogenerating layer and said top charge transport layer.

11. A photoconductor in accordance with claim 1 wherein said charge transport layer further contains an antioxidant comprised of a hindered phenol or a hindered amine.

12. A photoconductor in accordance with claim 1 wherein said melamine resin is represented by the following formulas/structures 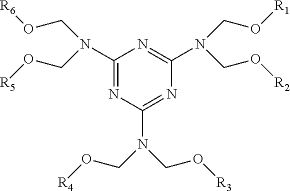
wherein R₁, R₂, R₃, R₄, R₅ and R₆ are selected from the group consisting of at least one of a hydrogen atom and an alkyl group.

13. A photoconductor in accordance with claim 1 where said melamine resin is selected from the group consisting of methylated melamine resins, methoxymethylated melamine resins, ethoxymethylated melamine resins, propoxymethylated melamine resins, butoxymethylated melamine resins, hexamethylol melamine resins, methoxymethylated melamine resins, ethoxymethylated melamine resins, propoxymethylated melamine resins, butoxymethylated melamine resins, and mixtures thereof.

14. A photoconductor in accordance with claim 1 wherein said charge transport compound in said overcoat layer is represented by 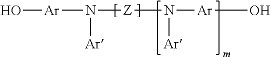
wherein m is 0 or 1; Z is selected from the group consisting of at least one of the components as represented by one of the following formulas/structures 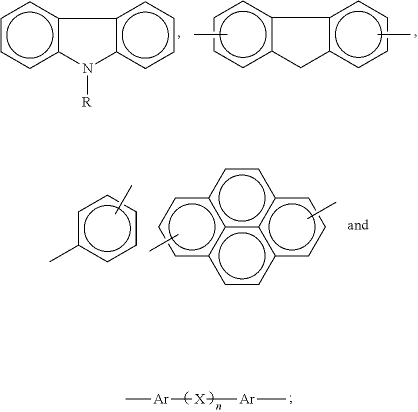
wherein n is 0 or 1, and R is alkyl; Ar is selected from the group consisting of 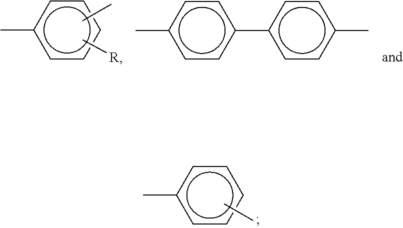
at least one of wherein R is alkyl; Ar′ is selected from the group consisting of at least one of 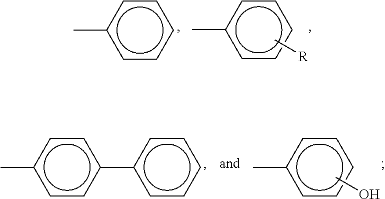
and X is selected from the group consisting of at least one of 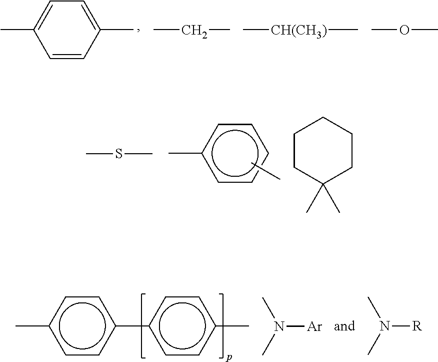
wherein p represents the number of segments of, for example, zero, 1, or 2; R is alkyl, and Ar is selected from the group consisting of at least one of the substituents represented by the following formulas/structures 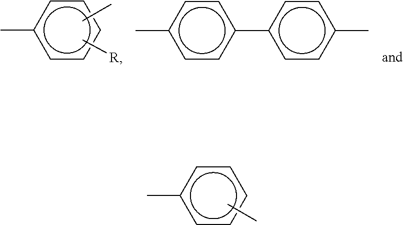
wherein R is alkyl.

15. A photoconductor in accordance with claim 1 wherein said charge transport compound in said overcoat layer is represented by the following formula/structure

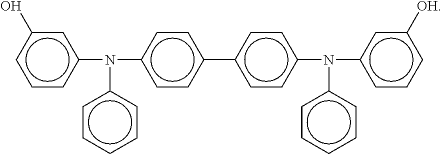

16. A photoconductor in accordance with claim 1 wherein said charge transport compound in said overcoat layer is represented by the following formulas/structures 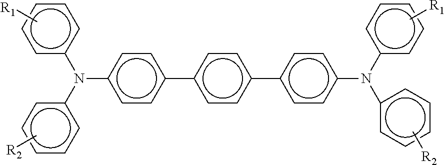
wherein each R₁ and R₂ is independently selected from the group consisting of at least one of a hydrogen atom, a hydroxy substituent, a substituent represented by —CₙH₂ₙ₊₁ where n is from 1 to about 12, and an aryl group containing from 6 to about 36 carbon atoms.

17. A photoconductor in accordance with claim 1 wherein said photogenerating layer is comprised of photogenerating pigments selected from the group consisting of a titanyl phthalocyanine, a halogallium phthalocyanine, a hydroxygallium phthalocyanine, and mixtures thereof.

18. A photoconductor in accordance with claim 1 wherein said hole blocking layer is present and is comprised of aminosilanes represented by the following formulas/structures 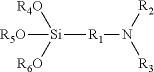
wherein R₁ is an alkylene containing from 1 to about 12 carbon atoms; R₂ and R₃ are independently selected from the group consisting of at least one of a hydrogen atom, alkyl containing from 1 to about 12 carbon atoms, and aryl containing from 6 to about 24 carbon atoms, and where R₄, R₅ and R₆ are alkyl groups containing from 1 to about 12 carbon atoms.

19. A photoconductor comprising a supporting substrate, a photogenerating layer, and a charge transport layer comprising a blend of a first charge transport compound and a second bis(butadienylaryl)arylamine charge transport compound additive, and a crosslinked overcoat layer comprising a charge transport compound, a melamine resin, and a hydroxyl terminated fluorinated additive, a hydroxyl silicone modified polyacrylate additive, or mixtures thereof.

20. A photoconductor comprising a photogenerating layer, a bis(enylaryl)arylamine containing charge transport layer, and an overcoat layer comprising a charge transport compound and a melamine resin, and wherein said photoconductor has a ghosting grade of from about −2.5 to about zero.
